(19) United States
(12) Patent Application Publication
(10) Pub. No.: US 2010/0036894 A1
(43) Pub. Date: Feb. 11, 2010

(54) DATA SYNCHRONIZATION METHOD, DATA SYNCHRONIZATION PROGRAM, DATABASE SERVER AND DATABASE SYSTEM

(76) Inventors: Riro SENDA, Yokohama (JP); Norihiro HARA, Kawasaki (JP); Tomohiro HANAI, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/367,052

(22) Filed: Feb. 6, 2009

(30) Foreign Application Priority Data
Aug. 5, 2008 (JP) 2008-201705

(51) Int. Cl. G06F 17/30

(52) U.S. Cl. 707/202; 707/E17.005; 707/E17.007

(57) ABSTRACT

A data synchronization method is provided to enhance reliability and performance of the database. The data reflection method selection unit of the active server weights collected values in the resource utilization table by multiplying the collected values by assessment coefficients assigned to the individual collected values in an assessment coefficient table and sums up the weighted values to calculate an assessment value for each data reflection method, and determines the data reflection method whose assessment value is minimum. The log data transmission unit, according to the determined data reflection method, sends log data that is reflected on the active database to the standby server, which forms one of the duplicated servers making up the redundant configuration. The data reflection method identifies the content to be transmitted.

### INCORPORATION BY REFERENCE

The present application claims priority from Japanese application JP2008-201705 filed on Aug. 5, 2008, the content of which is hereby incorporated by reference into this application.

### BACKGROUND OF THE INVENTION

The present invention relates to a technology of a data synchronization method, a data synchronization program, a database server and a database system.

Servers that handle services are computers and therefore have a possibility of failure. To avoid this, a fault-tolerant, highly reliable system has been proposed which comprises an active server and a standby server as a pair (see JP-A-2005-251055).

The system disclosed in JP-A-2005-251055 employs a redundant configuration having a plurality of servers in pairs. This redundant configuration realizes a data synchronization between the paired servers by sending data content managed by each of the paired servers to the other. In the event of a fault in one of the paired servers, the other server is brought into operation to continue servicing.

A server that operates a DBMS (Data Base Management System) is required to have especially high reliability to prevent loss of data being processed. For this reason, a connection between the paired servers is made redundant and data synchronization between the two servers is established in advance so as to prevent a possible loss of data in the event of a failure of one of the servers. Such a redundancy in the database system is particularly effective in an in-memory database that holds data in a main memory of the servers.

A further improvement in the database processing performance is also being called for. The database processing performance is measured by, for example, the number of transactions executed per unit time. In making such improvements, it is therefore important to enhance utilization of resources of the servers that execute the database services. For example, when a CPU load increases excessively as a result of data synchronization operation, the server may not be able to process new transactions, thus degrading the performance of the database.

The utilization, or rate of use, of server's resources changes over time. Utilization change occurs in the following situations, thus reducing the amount of server resources that the DBMS can use and degrading the availability of the database system.

When a temporary concentration of transactions on a particular DBMS results in a sharp increase in load on the server executing that DBMS;

When a single server is running a plurality of DBMS's concurrently, with a particular DBMS being used at low utilization but another DBMS being used at high utilization;

When, while a single server is operating one active system (with high load) and one standby system (with low load) concurrently in a redundant database, the standby system is made active in the event of a failure, resulting in the server running two active systems (with high load) at the same time; and

When a failure in particular hardware making up the server renders that hardware unusable and as a result increases the utilization of another hardware in the same server.

It is therefore a main objective of this invention to solve the above problem and improve database performance while at the same time enhance reliability of the database.

### SUMMARY OF THE INVENTION

To solve the above problem, this invention provides a data synchronization method for synchronizing data between an active database and a standby database in a database system, the database system being redundantly configured by having an active server to update data according to a command from a client and a standby server to take over processing from the active server in the event of a failure of the active server; wherein the active server has the active database and the standby server has the standby database; wherein the active server has, in addition to the active database, a resource utilization table, a resource utilization monitoring unit, a transaction control unit and a data reflection method selection unit; wherein the standby server has a log data application unit in addition to the standby database; wherein the transaction control unit, when it receives an operation command for specifying and updating data content, starts a transaction to process the received operation command and then reflects on the active database the content specified by the received operation command; wherein the resource utilization monitoring unit collects at least utilization information on resources in each of the servers making up the database system or database operation information and stores them in the resource utilization table; wherein the data reflection method selection unit weights collected values in the resource utilization table by multiplying the collected values by assessment coefficients assigned to the individual collected values in an assessment coefficient table and sums up the weighted values to calculate an assessment value for each data reflection method, and determines the data reflection method whose assessment value is minimum; wherein a log data transmission unit, according to the determined data reflection method, sends log data that is reflected on the active database to the standby server, which forms one of the duplicated servers making up the redundant configuration; wherein, when a finalize command to finalize the transaction is transmitted from the client to the active server, the log data application unit reflects the received log data on the standby database; wherein the data reflection method is defined by selecting one of log data content transmitting methods shown in (a) and (b): (a) Transmitting data log representing a content of data to be updated in the database but not an index log representing a content of index update to the content of data, the index log being created on the standby server side instead, and (b) Transmitting index log in addition to the data log. The other solution will be described, later.

With this invention, it is possible to improve the performance of the database while enhancing its reliability.

Other objects, features and advantages of the invention will become apparent from the following description of the embodiments of the invention taken in conjunction with the accompanying drawings.

### BRIEF DESCRIPTION OF THE DRAWINGS

FIG. 1 shows a hardware configuration of the database system according to one embodiment of this invention.

FIG. 2 shows details of servers in the database system according to one embodiment of this invention.

FIG. 3 is a flow chart showing a process of selecting a data reflection method according to one embodiment of this invention.

FIG. 4 is a flow chart showing a process of executing a data reflection method (1) according to one embodiment of this invention.

FIG. 5 is a flow chart showing a process of executing a data reflection method (2) according to one embodiment of this invention.

FIG. 6 is a flow chart showing a process of executing a data reflection method (3) according to one embodiment of this invention.

FIG. 7 is a flow chart showing a process of executing a data reflection method (4) according to one embodiment of this invention.

FIG. 8 is a flow chart showing a process of executing the data reflection method (1) with the standby server of a clustering configuration.

### DETAIL DESCRIPTION OF THE EMBODIMENTS

Now, one embodiment of a database system that applies the present invention will be described in detail by referring to the accompanying drawings.

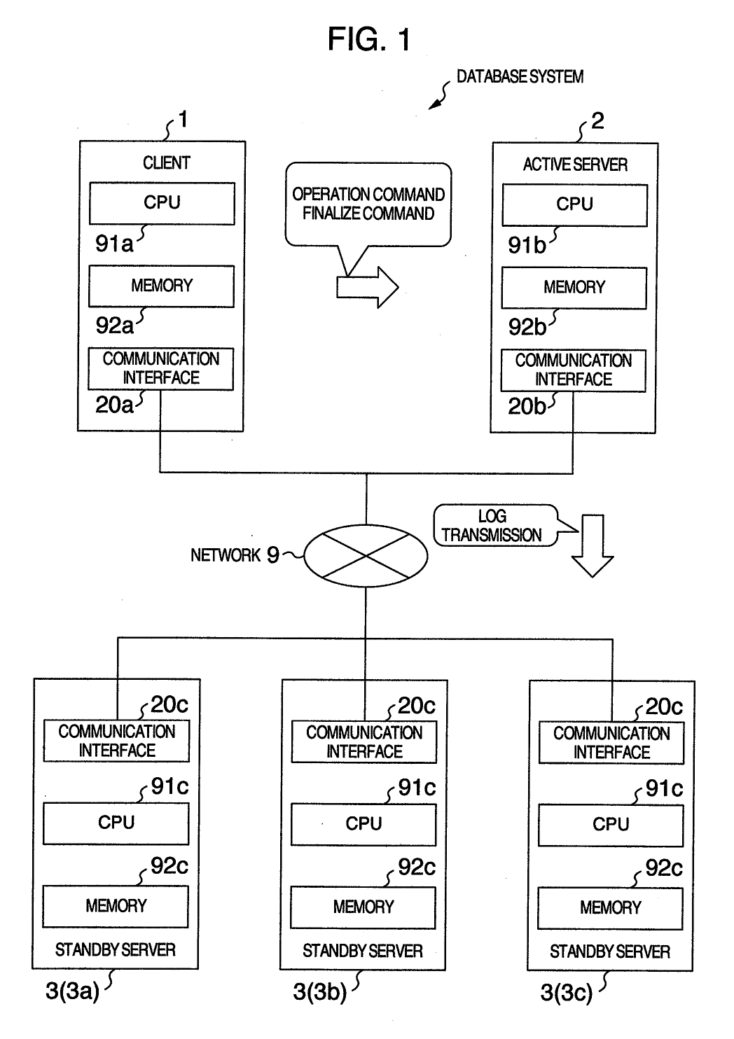

FIG. 1 shows a hardware configuration of the database system. The database system comprises a client 1, an active server 2 and a standby server 3 (standby server 3a, standby server 3b and standby server 3c), all interconnected via a network 9. The number of standby servers 3 may be one or two or more (in the case of FIG. 1, three standby servers are shown) in a clustered configuration.

The network 9 is configured as an IP (Internet Protocol) network or, when servers (active server 2 and standby server 3) are blade servers, as an internal bus.

Each of the devices in FIG. 1 (client 1, active server 2 and standby server 3) has at least a memory 92 (92a, 92b, 92c) used during computation, a computation processor to execute computation and a communication interface 20 (20a, 20b, 20c) that communicates with other devices via the network 9. The memory is constructed of a RAM (Random Access Memory). The computation function is realized by the computation processor—which is constructed of a CPU (Central Processing Unit) 91 (91a, 91b, 91c)—executing programs on the memory.

The client 1 makes a request to the active server 2 for an access to a database managed by the active server 2. The access command can be classified into at least two kinds (operation command and finalize command) shown below. A session of transaction is started for the request from the client 1 to be serviced by the active server 2.

The “operation command” is a message that requests an operation to be executed on the content of data stored in the database. The operation command may include such operations as insert, update and delete to rewrite the data content. In one transaction session zero or more operation commands occur. The active server 2, when it receives a first operation command, may start a transaction associated with the operation command if that transaction has not yet started.

The “finalize command” is a message that determines whether or not to finalize the data content that was rewritten in the database by the operation command. The finalize commands are grouped into a “commit command” that finalizes the rewritten data content and a “rollback command” that discards the rewritten data content. In response to the finalize command, the transaction either finalizes or discards the data content before exiting.

The active server 2 provides database services to the client 1. More specifically, the active server 2 receives a request (such as operation command, finalize command) and reflects the data content specified by the command on the database that it manages.

The active server 2 and the standby server 3 adopt a redundant configuration as a countermeasure against failures. When a fault occurs in the active server 2, the standby server 3 plays the role of the active server 2 by taking over the tasks of the failed active server 2.

Thus, although the active server 2 and the standby server 3 have different names, one and the same server operates as the active server 2 in one time period and also as the standby server 3 in another time period. So, the active server 2 and the standby server 3 employ the same device construction.

To ensure a smooth transfer of the role from the active server 2 to the standby server 3 in the event of a failure, the content of database in the active server 2 and the content of database in the standby server 3 are made the same (or synchronized).

While the content of database in the active server 2 is updated as the active server 2 directly receives an operation command from the client 1, since the standby server 3 does not communicate directly with the client 1, it cannot directly know the most recent content of database. So, the standby server 3 indirectly receives the updated content of database from the active server 2 in the form of a differentiation type log.

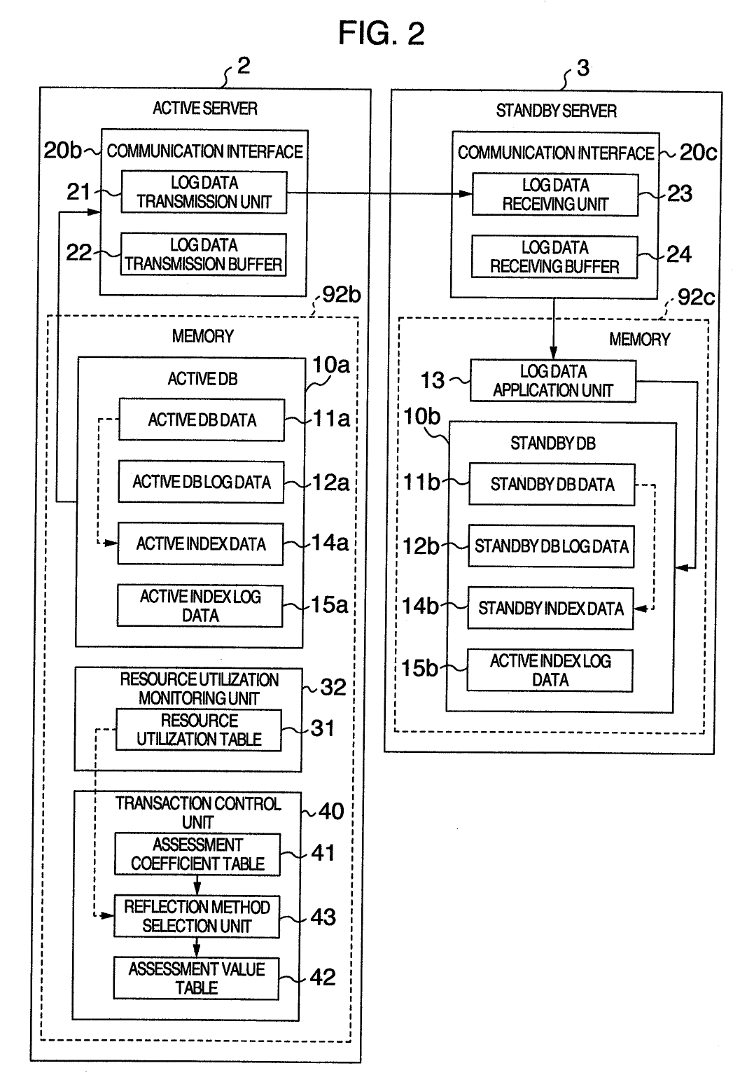

FIG. 2 shows a detailed configuration of the servers (active server 2, standby server 3) in the database system.

The active server 2 has a communication interface 20b, an active DB 10a, a resource utilization monitoring unit 32 and a transaction control unit 40.

The standby server 3 has a communication interface 20c, a log data application unit 13 and a standby DB 10b.

Each of the databases (active DB 10a, standby DB 10b) may be an in-memory database that stores data in a volatile memory device (memory 92) in the server to which the database belongs. They may also be a database that stores data in a nonvolatile hard disk drive.

For example, the memory 92b may store the active DB 10a and the memory 92c the standby DB 10b.

When a hard disk drive is used, on the other hand, data can be transferred using a shared disk (not shown).

Further, processing units of the active server 2 (resource utilization monitoring unit 32, transaction control unit 40) may be provided on the memory 92b of the active server 2 by the CPU 91b of the active server 2 executing a program.

Similarly, the log data application unit 13 of the standby server 3 may be provided on the memory 92c of the standby server 3 by the CPU 91c of the standby server 3 executing a program.

Although FIG. 2 shows the active server 2 and the standby server 3 to have different constitutional elements, since the roles of these servers are switched over, each of the servers includes the constitutional elements in FIG. 2 of both the active server 2 and the standby server 3.

As for the log data application unit 13 for example, which is actually a part of the active server 2 but not shown in FIG. 2, it is omitted in FIG. 2 for the sake of simplicity because it is not activated in the active server 2.

In a time period when a server of interest is operating as the active server 2, it does not use the constitutional elements of the standby server 3. So, until it begins to function as the standby server 3, the server of interest may be configured not to have the constitutional elements of the standby server 3. And when the server of interest is switched into the standby server 3, a program may be executed to realize the constitutional elements of the standby server 3 so that they can be used by the server of interest.

The communication interface 20b of the active server 2 has a log data transmission unit 21 and a log data transmission buffer 22.

The communication interface 20c of the standby server 3 has a log data receiving unit 23 and a log data receiving buffer 24.

The log data transmission buffer 22 temporarily stores log data (active DB log data 12a, active index data 14a) that is read from the active DB 10a, until it is transmitted.

The log data transmission unit 21 sends to the log data receiving unit 23 the log data to be transmitted that is temporarily stored in the log data transmission buffer 22.

The log data receiving unit 23 stores in the log data receiving buffer 24 the log data it received from the log data transmission unit 21.

The log data receiving buffer 24 temporarily stores the received log data until it is applied by the log data application unit 13.

The active server 2 has the active DB 10a and the standby server 3 has the standby DB 10b. The active DB 10a and the standby DB 10b both store the same content of data after the transaction is finished because data synchronization is done between the two databases during the transaction.

First, the active DB 10a stores active DB data 11a, active DB log data 12a, active index data 14a and active index log data 15a.

Similarly, the standby DB 10b stores standby DB data 11b, standby DB log data 12b, standby index data 14b and standby index log data 15b.

That is, there is a correspondence between the active DB data 11a and the standby DB data 11b, between the active DB log data 12a and the standby DB log data 12b, between the active index data 14a and the standby index data 14b; and between the active index log data 15a and standby index log data 15b. After the transaction is over, the corresponding two groups of data have the same content.

TABLE 1
11a: Active DB data (before log data is reflected)

| | |
|---|---|
| Row | Row data |

| ID | Col. 1 | Col. 2 | . . . | Col. n |
|---|---|---|---|---|
| 1 | A | B | . . . | C |
| 2 | D | E | . . . | F |
| . | . | . | . . . | . |
| . | . | . | | . |
| . | . | . | | . |

12a: Active DB log data 12a

| Transaction | Operation | Row | Row data | | | |
|---|---|---|---|---|---|---|
| No. | category | ID | Col. 1 | Col. 2 | . . . | Col. n |
| 10 | Update | 1 | A2 | B2 | . . . | C2 |
| 10 | Delete | 2 | — | — | . . . | — |
| 10 | Insert | 100 | X | Y | . . . | Z |
| . | . | . | . | . | . . . | . |
| . | . | . | . | . | | . |
| . | . | . | . | . | | . |

11a: Active DB data (after log data is reflected)

| | |
|---|---|
| Row | Row data |

| ID | Col. 1 | Col. 2 | . . . | Col. n |
|---|---|---|---|---|
| 1 | A2 | B2 | . . . | C2 |
| 2 | — | — | . . . | — |
| . | . | . | . . . | . |
| . | . | . | | . |
| . | . | . | | . |
| 100 | X | Y | . . . | Z |
| . | . | . | . . . | . |
| . | . | . | | . |
| . | . | . | | . |

Table 1 shows one example of how the active DB log data 12a is reflected on the active DB data 11a. Three tables in Table 1 are, from the top downward, the active DB data 11a (before log data is reflected), the active DB log data 12a, and the active DB data 11a (after log data has been reflected).

The active DB data 11a (before and after the log data is reflected) has a row ID and row data, that makes up the row, arranged in a matching relationship for each row (for each record). The row data comprises one or more column elements (in Table 1, n column elements from column 1 to column n).

The active DB log data 12a shows the updated history of the active DB data 11a in a differential format as a result of an operation command from the client 1. The active DB log data 12a has the transaction serial number, operation category, row ID and row data arranged in a matching relationship. Parameters of the active DB log data 12a are extracted from the operation command from the client 1.

For example, a first row record is a record added by the operation command “update” in the transaction of transaction number “10”. The object to be operated upon has a row ID “1” and the operation to be executed is an updating of the row data “A2, B2, . . . , C2”.

The operation category is either “insert”, “update” or “delete”. Data content is rewritten by these operations. So, the row data in the active DB log data 12a represents the rewritten data.

The active DB data 11a (after log data is reflected) is the result of reflecting the active DB log data 12a on the active DB data 11a (before log data is reflected), triggered by the reception of a finalize command for a transaction. For example, when a finalize command for the transaction number “10” is received, a record with transaction number “10” is picked up from among the records in the active DB log data 12a and is reflected on the active DB data 11a. As a result, the record of row ID “1” in the active DB data 11a (after log data is reflected) is updated from “A, B, . . . , C” to “A2, B2, . . . , C2”.

TABLE 2
14a: Active index data (before log data is reflected)

| Row data | |
|---|---|
| key value | Row ID |
| B | 1, 10, 12 |
| C | 1, 5, 6, 24 |
| . | . |
| . | . |
| . | . |

15a: Active index log data

| Transaction | Operation | Row data | |
|---|---|---|---|
| serial number | category | key value | Row ID |
| 10 | Delete | B | 1 |
| 10 | Add | B2 | 1 |
| 10 | Delete | C | 1 |
| 10 | Add | C2 | 1 |
| 10 | Delete | E | 2 |
| 10 | Add | Y | 100 |
| . | . | . | . |
| . | . | . | . |
| . | . | . | . |

14a: Active index data (after log data is reflected)

| Row data | |
|---|---|
| key value | Row ID |
| B | 10, 12 |
| B2 | 1 |
| C | 5, 6, 24 |
| C2 | 1 |
| . | . |
| . | . |
| . | . |

Table 2 shows an example of reflecting the active index log data 15a on the active index data 14a. Three tables in Table 2 are, from top to bottom, the active index data 14a (before log data is reflected), the active index log data 15a and the active index data 14a (after log data is reflected).

The active index data 14a (before and after log data is reflected) has one row data key value and one or more row ID arranged in a matching relationship.

The row data key value represents a value that column elements in the row data of the active DB data 11a can take, and is a search key, in an access request such as operation command to the active DB data 11a, to locate the access target.

The row ID is a list of rows having column elements in which the row data key value exists.

By generating the active index data 14a as described above, the efficiency in accessing the active DB data 11a is enhanced. That is, when a row data key value is specified as a search key, the active server, rather than actually searching through all the row data of the active DB data 11a, searches through the active index data 14a only once to be able to quickly search for the row ID of the active DB data 11a to be accessed.

The active index log data 15a shows an update history of the active index data 14a in a differential format. The active index data 14a describes (summarizes) the active DB data 11a and therefore is updated along with the active DB data 11a.

The active index log data 15a has the transaction serial number, the operation category, the row ID and the row data key value arranged in a matching relationship. Parameters of the active index log data 15a are extracted from the operation commands from the client 1.

The transaction serial number locates the transaction that accepts an operation command.

The row ID and the row data key value represent the content of update to the active index data 14a.

The operation category is either “add” or “delete”. The matching relation between the operation command and the operation category is as follows. An operation command of “insert” corresponds to an operation category of “add”; an operation command of “delete” corresponds to an operation category of “delete”; and an operation command of “update” corresponds to operation categories of “add, delete”. For example, one operation command of “update A to B” can be divided into one operation category of “delete A” and one operation category of “add B”.

When the operation category is “add”, the corresponding “row ID” and “row data key value” are a value to be written into a newly added row in the active index data 14a or a value to be overwritten in the existing row.

When the operation category is “delete”, the corresponding “row ID” and “row data key value” are a value written in a row that is to be deleted from the active index data 14a or a value in the existing row before being updated.

In Table 2, a first row record in the active index log data 15a (“10”, “delete”, “B”, “1”), for example, is a record added by an operation command in the transaction of transaction serial number “10” and specifies an execution of an operation category of “delete” on a combination of a row ID of “1” and a row data key value of “B” in the active index data 14a.

Therefore, when the active index log data 15a is applied to the active index data 14a (before log data is reflected), the row ID containing the row data key value of “B” has “1” to be deleted from “1, 10, 12” and as a result becomes “10, 12”.

The resource utilization monitoring unit 32 monitors the utilization of resources of the local active server 2 and its associated standby server 3 and the operation conditions of the database system. The resources refer, for example, to CPUs, memories and network bands.

TABLE 3
31: Resource utilization table

| | | | | | Log receiving | Decision |
|---|---|---|---|---|---|---|
| | Active server | | Standby server | | buffer | command |
| | CPU | Memory | CPU | Memory | queue | response |
| | utilization | utilization | utilization | utilization | length | time |
| Utilization | R1 | R2 | R3 | R4 | R5 | R6 |

The resource utilization table 31 of Table 3 stores the resource utilization conditions obtained as a result of monitoring by the resource utilization monitoring unit 32 and the operation condition of the database system.

Therefore, the resource utilization table 31 stores, for example, a CPU utilization R1 of the active server 2, a memory utilization R2 of the active server 2, a CPU utilization R3 of the standby server 3, a memory utilization R4 of the standby server 3, a buffer queue length R5 of the log data receiving unit 23, and a response time R6 for the finalize command from the client 1.

The transaction control unit 40 performs control on the transaction for the local active server 2 and the client 1. More specifically, the transaction control unit 40 performs the following processing.

Management of transaction serial number: The transaction serial number is a number to identify each transaction and is incremented (by one) each time the transaction is finished. In the same transaction, when a plurality of operation commands are accepted, transaction serial numbers of the records that are written by these operation commands are all the same. Further, the active server 2 and the standby server 3 use the same transaction serial numbers.

Processing of operation command: When an operation command is accepted from the client 1, the active DB log data 12a and the active index log data 15a are generated based on the “row ID, row data key value, operation category” specified by the operation command, and matched to the current transaction serial number before being written into the active DB 10a.

Reflecting of log data: As shown in Table 1, the active DB log data 12a is reflected on the active DB data 11a. At the same time, as shown in Table 2, the active index log data 15a is reflected on the active index data 14a.

Instruction to send log data: Log data to be transmitted (either only the active DB log data 12a or a combination of the active DB log data 12a and the active index log data 15a) is written in the log data transmission buffer 22 to instruct the transmission of the log data.

Processing of finalize command: Upon receiving a finalize command from the client 1, the transaction control unit 40 instructs the active server to send all the log data that have yet to be transmitted to the standby server 3 and write the log data to be transmitted into the standby DB 10b (i.e., synchronize the data content).

Further, as one feature of this embodiment, the transaction control unit 40 has provisions that, when there are two or more data reflection methods for data synchronization, allow for selecting one of the data reflection methods.

TABLE 4
Reflection method definition table

| Reflection | | |
|---|---|---|
| method | What is transmitted | Transmission trigger |
| Method (1) | Active DB log data | When finalize |
| | Active index log data | command is received |
| Method (2) | Active DB log data | When finalize |
| | | command is received |
| Method (3) | Active DB log data | When operation |
| | Active index log data | command is received |
| Method (4) | Active DB log data | When operation |
| | | command is received |

Table 4 shows definitions of data reflection methods. This table presents a total of four data reflection methods (1) to (4) based on a combination of two data contents to be transmitted and two transmission triggers. These four data reflection methods differ in performance as follows while all of them maintain a basic feature of being able to realize the data synchronization between the active DB 10a and the standby DB 10b by reflecting changes of the active DB data 11a on the standby DB data 10b.

The features of these methods are as follows as viewed from the standpoint of transmission trigger.

Methods (1, 2) transmit log data when a finalize command is received, so they can keep the CPU utilization in the active server 2 low until the finalize command is received.

Methods (3, 4) transmit log data when an operation command is received. So, the database processing and the transmission processing are parallelly executed in the active server 2 before it receives the finalize command, shortening the overall response time of the transaction.

When viewed from the standpoint of data content, these methods have the following features.

Methods (1, 3) send a combination of the active DB data 11a and the active index log data 15a, so the standby server 3 on the receiving end does not need to newly generate the standby index log data 15b but to copy the active index log data 15a as the standby index log data 15b. As a result, the CPU utilization in the standby server 3 can be kept low.

Methods (2, 4) omit sending the active index log data 15a, so there is no need to store the active index log data 15a in the log data transmission buffer 22 and the log data receiving buffer 24. This allows the buffer capacities to be reduced, keeping the memory utilization in both servers and the CPU utilization of the active server 2 low.

As described above, the definition table for a total of four data reflection methods (1) to (4) is composed of a combination of two transmission triggers and two data contents to be transmitted. As another embodiment, a data reflection method definition table may be composed of two transmission triggers, or of two data contents.

TABLE 5
41: Assessment coefficient table

| | | | | | Log | |
|---|---|---|---|---|---|---|
| | | | | | receiv- | |
| Data | Active server | | standby server | | ing | Decision |
| reflec- | CPU | | CPU | | buffer | command |
| tion | utili- | Memory | utili- | Memory | queue | response |
| method | zation | utilization | zation | utilization | length | time |
| Method | C11 | C12 | C13 | C14 | C15 | C16 |
| (1) | | | | | | |
| Method | C21 | C22 | C23 | C24 | C25 | C26 |
| (2) | | | | | | |
| Method | C31 | C32 | C33 | C34 | C35 | C36 |
| (3) | | | | | | |
| Method | C41 | C42 | C43 | C44 | C45 | C46 |
| (4) | | | | | | |

42: Assessment value table

| | Data reflection method | | | |
|---|---|---|---|---|
| | Method (1) | Method (2) | Method (3) | Method (4) |
| Assessed | E1 | E2 | E3 | E4 |
| value | | | | |

43: Data reflection method selection unit 43
(assessment value calculation formula)

| Data reflection | Assessment value calculation formula (summing of |
|---|---|
| method | weighting factor) |
| Method (1) | E1 = C11 × R1 + C12 × R2 + C13 × R3 + |
| | C14 × R4 + C15 × R5 + C16 × R6 |
| Method (2) | E2 = C21 × R1 + C22 × R2 + C23 × R3 + |
| | C24 × R4 + C25 × R5 + C26 × R6 |
| Method (3) | E3 = C31 × R1 + C32 × R2 + C33 × R3 + |
| | C34 × R4 + C35 × R5 + C36 × R6 |
| Method (4) | E1 = C41 × R1 + C42 × R2 + C43 × R3 + |
| | C44 × R4 + C45 × R5 + C46 × R6 |

The transaction control unit 40 has an assessment coefficient table 41 (top of Table 5), an assessment value table 42 (middle of Table 5) and a data reflection method selection unit 43 (bottom of Table 5).

The assessment coefficient table 41 stores for each data reflection method an assessment coefficient by which to multiply (weight) each column element in the resource utilization table 31. Thus, the format of the column elements of the assessment coefficient table 41 is the same as that of the column elements of the resource utilization table 31. The assessment coefficient indicates that as the coefficient increases, the amount of the resource used or required time increases.

The assessment value table 42 stores for each data reflection method an assessment value that the data reflection method selection unit 43 has determined by referencing the resource utilization table 31 and the assessment coefficient table 41. It is noted that the smaller the assessment value, the more likely it is for the method concerned to be adopted (i.e., highly evaluated) as the data reflection method.

The data reflection method selection unit 43 multiplies (performs a weighting operation on) the corresponding two column elements (a column element of the resource utilization table 31 and a column element of the assessment coefficient table 41) and then sums up the calculated results to determine an assessment value for each data reflection method. The formula for summing the weighted results is shown in Table 5.

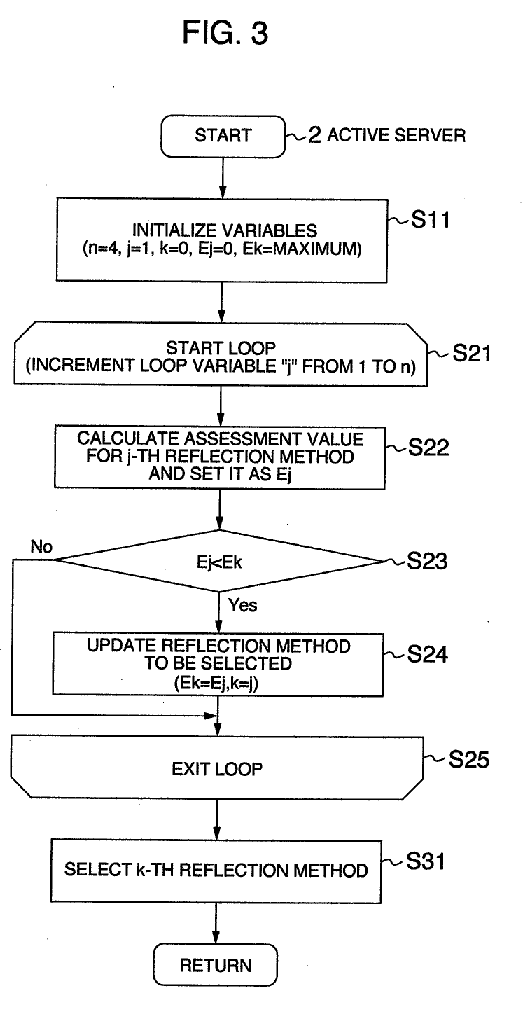

FIG. 3 is a flow chart showing a process for the data reflection method selection unit 43 to select the data reflection method.

First, parameters shown below are initialized (S11).

A parameter “n” represents the number of data reflection methods available, and a maximum data reflection method number (e.g., 4 when there are four methods as shown in Table 4) is entered into the parameter.

A parameter “j” is a loop control parameter which is incremented by one each time a loop is executed once, and represents a serial number of the data reflection method currently used. An initial value of “1” is entered.

A parameter “Ej” represents an assessment value of j-th method currently being used. An initial value of “0 (which means that no calculation has yet been done)” is entered.

A parameter “Ek” represents the smallest of the previously calculated parameters “Ej”. A sufficiently large value (the maximum value that this parameter can take) is entered as an initial value. Thus, the value of parameter “Ej” calculated first time surely replaces the value of the parameter “Ek”.

A parameter “k” represents a data reflection method number that is most likely to be currently selected. As an initial value, “0 (which means that no data reflection method has yet been determined)” is entered.

Next, a loop (S21-S25) to calculate an assessment value for each data reflection method is executed. This loop evaluates one reflection method at a time, starting from the initial value “1” of the loop control parameter “j”, incrementing it by 1 after each execution of the loop and exiting when the loop control parameter is equal to the value of parameter “n”+1.

In the loop, an assessment value for a j-th reflection method is calculated (S22). More specifically, values in the resource utilization table 31 and values in the assessment coefficient table 41 are weighted and summed up to obtain a single assessment value for the j-th reflection method. The total assessment value is written into the assessment value table 42 and substituted into the parameter “Ej”.

Next, a check is made to determine whether the parameter “Ej” just calculated is lower than the previously calculated minimum value “Ek” according to a decision formula “Ej<Ek” (S23). If the decision formula is satisfied (S23, yes), the data reflection method selection unit 43 substitutes the parameter “Ej” calculated this time into the minimum value “Ek” and also substitutes the value of the parameter “j” (reflection method number) into the parameter “k” (S24) to update the reflection method number that is highly likely to be chosen. As described above, the loop of S21-S25 determines the reflection method number with the lowest assessment value as the value of the parameter “k”.

Outside the loop, the data reflection method selection unit 43 determines the k-th reflection method calculated by the loop as the reflection method to be used in the current transaction (S31).

TABLE 6

| | | | | | Log | |
|---|---|---|---|---|---|---|
| | | | | | receiving | Decision |
| Data | Active server | | Standby server | | buffer | command |
| reflection | CPU | Memory | CPU | Memory | queue | response |
| method | utilization | utilization | utilization | utilization | length | time |

31: Resource utilization table

| | | | | | | |
|---|---|---|---|---|---|---|
| Case (1) | 0.1 | 0.6 | 2 0.3 | 0.6 | 0.2 | 0.5 |
| Case (2) | 0.5 | 0.6 | 0.3 | 0.6 | 0.2 | 0.5 |
| Case (3) | 0.3 | 0.6 | 0.9 | 0.6 | 0.2 | 0.5 |
| Case (4) | 0.1 | 0.6 | 0.8 | 0.6 | 0.2 | 0.5 |

41: Assessment coefficient table

| | | | | | | |
|---|---|---|---|---|---|---|
| Method (1) | 60 | 40 | 30 | 40 | 20 | 70 |
| Method (2) | 55 | 30 | 50 | 30 | 15 | 70 |
| Method (3) | 75 | 40 | 32 | 40 | 28 | 55 |
| Method (4) | 70 | 30 | 55 | 30 | 25 | 50 |

42: Assessment value table

Data reflection method

| Assessed | Method | | Method | Method |
|---|---|---|---|---|
| value | (1) | Method (2) | (3) | (4) |
| Case (1) | 102.0 | 94.5 | 98.2 | 89.5 |
| | | | | (Chosen) |
| Case (2) | 126.0 | 116.5 | 128.2 | 117.5 |
| | | (Chosen) | | |
| Case (3) | 132.0 | 135.5 | 132.4 | 136.5 |
| | (Chosen) | | | |
| Case (4) | 117.0 | 119.5 | 114.2 | 117.0 |
| | | | (Chosen) | |

Table 6 shows one example obtained as a result of executing the flow chart of FIG. 3. The underlined reflection methods are the ones to be adopted.

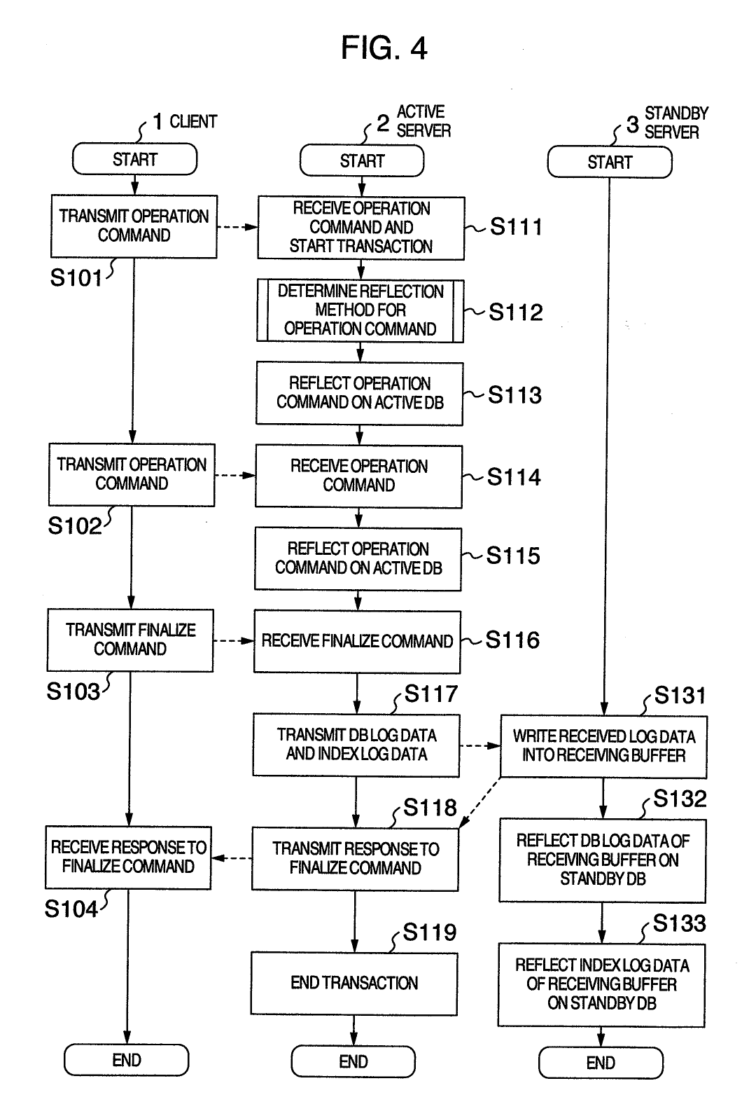

FIG. 4 is a flow chart showing the process of executing the reflection method (1). This reflection method (1) is chosen by S112.

First, when the client 1 sends its first operation command (S101), the transaction control unit 40 of the active server 2 receives the operation command and starts a transaction (S111).

The data reflection method selection unit 43 calls up an operation for selecting a data reflection method (see FIG. 3) to determine the method of data reflection for the operation command (S112).

The transaction control unit 40, based on the data content specified by the first operation command received, generates the active DB log data 12a and the active index log data 15a and then reflects them on the active DB 10a (S113).

Next, the client 1 sends a second operation command (S102) and the transaction control unit 40 of the active server 2 receives the operation command (S114).

Based on the data content specified by the second operation command received, the transaction control unit 40 generates the active DB log data 12a and the active index log data 15a and reflects them on the active DB 10a (S115).

Here, the client 1 sends a finalize command (S103) and the transaction control unit 40 of the active server 2 receives the finalize command (S116).

The log data transmission unit 21 sends to the log data receiving unit 23 the log data (active DB log data 12a and active index log data 15a) generated in response to the two operation commands as the log data to be transmitted (S117). As described above, when a plurality of operation commands occur before a finalize command is received, log data for one operation command may be transmitted in one transmission operation or log data for a plurality of operation commands may be transmitted en masse in one transmission operation.

The log data receiving unit 23 writes the log data it received from the log data transmission unit 21 into the log data receiving buffer 24 (S131). If all of the log data to be transmitted have been received normally in S131, the log data receiving unit 23 may return an acknowledge (ACK) response to the data transmitting active server 2 (indicated by a dashed line arrow in FIG. 4). When, after data transmission, an ACK is not received, the active server 2 performs an error countermeasure such as retransmitting the content of the log whose transmission resulted in an error.

The log data application unit 13 reads the received log data (active DB log data 12a) from the log data receiving buffer 24 and reflects it on the standby DB 10b (standby DB log data 12b) (S132).

The log data application unit 13 reads the received log data (active index log data 15a) from the log data receiving buffer 24 and reflects it on the standby DB 10b (standby index log data 15b) (S133).

After receiving the ACK from the standby server 3, the transaction control unit 40 in response to the received finalize command (S116) sends response data (S118) before ending the transaction (S119). The client 1 receives the response data for the finalize command it already transmitted (S103) from the active server 2 (S104).

As described above, the reflection method (1) shown in FIG. 4 is characterized by transmitting two kinds of log data (active DB log data 12a and active index log data 15a) with the reception of the finalize command taken as a transmission trigger (see S117).

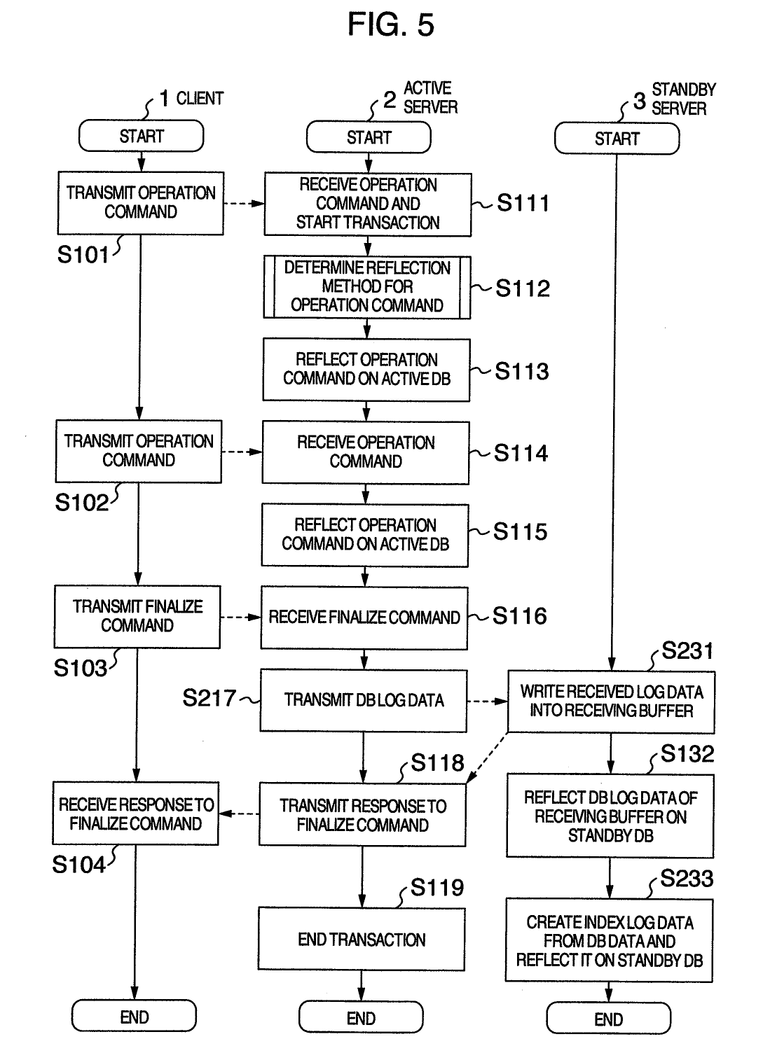

FIG. 5 is a flow chart showing the process of executing the reflection method (2). This reflection method (2) is chosen by S112. In the following, the same steps as those of the reflection method (1) of FIG. 4 are given like reference numbers and our explanation focuses on differences from the reflection method (1).

The process of receiving two operation commands and that of reflecting data content are identical with those of FIG. 4 (S101-S116).

Next, when a finalize command is received (S116), one kind of log data (active DB log data 12a) is transmitted (S217), rather than two kinds of log data that were sent in the case of FIG. 4 (S117). The standby server 3 writes the received active DB log data 12a into the receiving buffer (S231).

Although the process of reflecting the active DB log data 12a is the same in FIG. 4 and FIG. 5 (S132), since the active index log data 15a is not transmitted in FIG. 5, the standby server 3 newly creates index log data from the standby DB data 11b and the standby DB log data 12b of the standby DB 10b and reflects it on the standby index log data 15b of the standby DB 10b (S233).

As described above, the reflection method (2) of FIG. 5 is characterized in that it sends only one kind of log data (active DB log data 12a) upon receiving a finalize command as a trigger for log data transmission (see S217).

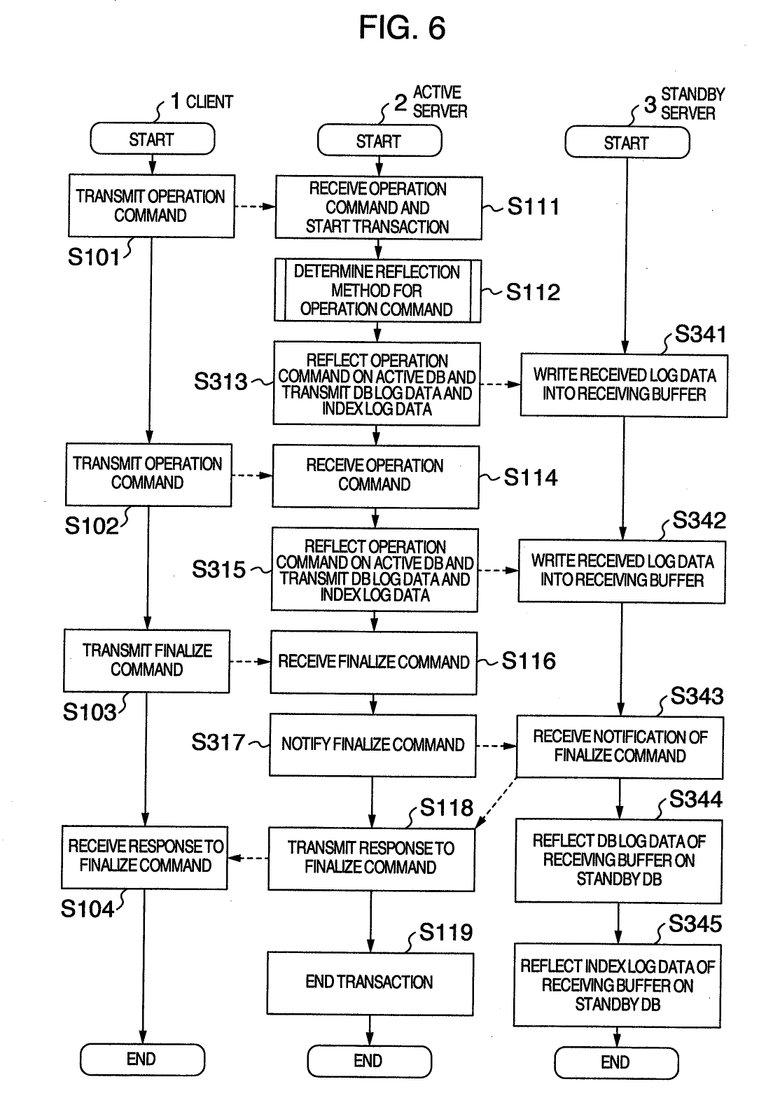

FIG. 6 is a flow chart showing the process of executing the reflection method (3). This reflection method (3) is chosen by S112. In the following, the same steps as those of the reflection method (1) of FIG. 4 are given like reference numbers and our explanation focuses on differences from the reflection method (1).

First, when a first operation command is received (S101), the received content is reflected on the active DB 10a. Up to this point, the process is the same as S113 of FIG. 4. This is followed by two kinds of log data (active DB log data 12a and active index log data 15a) being created and sent to the standby server 3 (S313).

The standby server 3 writes the received log data into the log data receiving buffer 24 (S341). It is noted that at this point in time the log data is not reflected on the standby DB 10b.

Similarly, a process for a second operation command is performed (S315, S342). That is, the log data transmission operation is done as many times as the operation commands have occurred.

Since there is a possibility that two or more operation commands may occur, it is desired that the standby server 3 not return the reception acknowledgement (ACK) when it receives the log data (S341, S342) and that immediately after transmitting the log data (S313), the active server 2 be allowed to proceed to receive the next operation command (S114).

Then, when it receives a finalize command (S116), the active server 2 notifies the standby server 3 of the reception of the finalize command (S317) since it has already finished the log data transmission (S341, S342). The standby server 3 receives the notification (S343). In a step that corresponds to the ACK transmission in FIG. 4, if all of a plurality of log data receptions are successfully completed (S341, S342), the standby server 3 performs one ACK sending operation.

The two kinds of received log data are reflected (S344, S345) in the same way as the processing of FIG. 4 (S132, S133) because the transmitted contents are the same though the transmission triggers are different between FIG. 4 and FIG. 6.

As described above, the reflection method (3) of FIG. 6 is characterized in that it transmits two kinds of log data (active DB log data 12a and active index log data 15a) upon receiving the operation command as a trigger for the log data transmission (S313, S315).

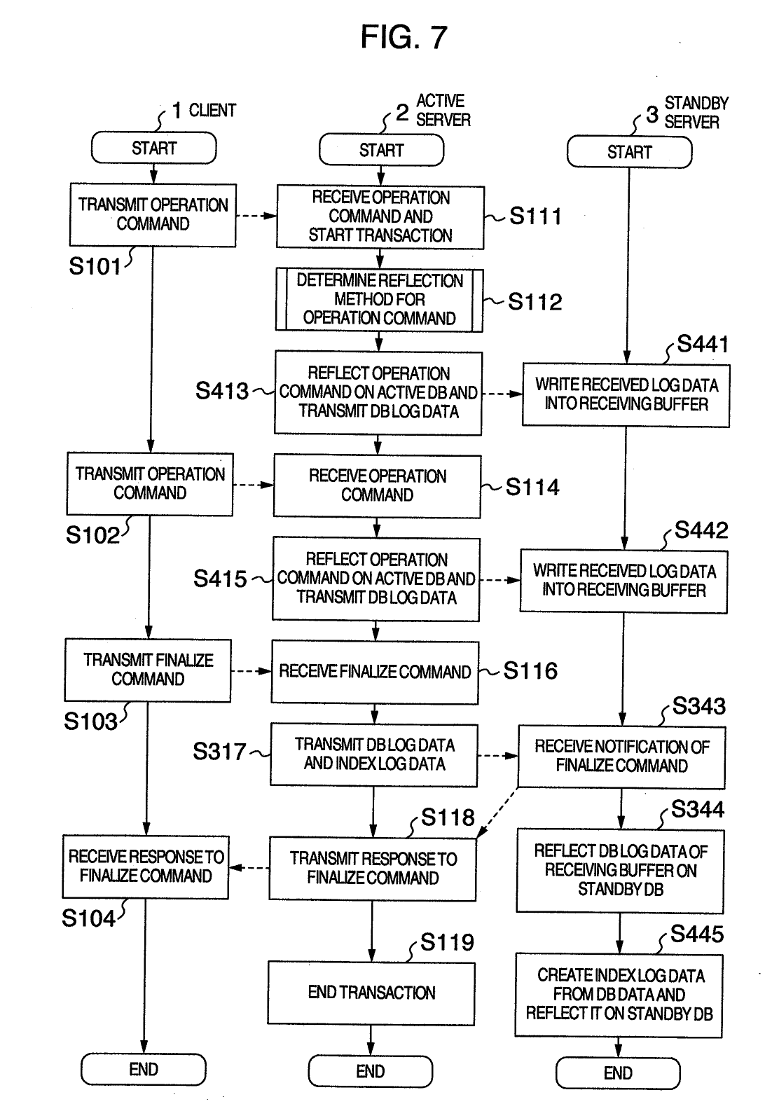

FIG. 7 is a flow chart showing the process of executing the reflection method (4). This reflection method (4) is chosen by S112. In the following, the same steps as those of the reflection method (3) of FIG. 6 are given like reference numbers and our explanation focuses on differences from the reflection method (3).

While the log data transmission triggers are the same in FIG. 6 and FIG. 7, this reflection method (4) of FIG. 7 transmits only one kind of log data (active DB log data 12a). No active index log data 15a is transmitted (S413, S415). Thus, the standby server 3 writes only the active DB log data 12a into the log data receiving buffer 24 (S441, S442).

Next, after receiving a finalize command, the standby server 3 reflects the active DB log data 12a on the standby DB log data 12b. This is done both in FIG. 6 and FIG. 7 (S344).

But since the active index log data 15a is not transmitted, log data is created as in S233 of FIG. 5 and reflected on the standby index log data 15b (S445).

As explained above, the reflection method (4) of FIG. 7 is characterized in that it sends only one kind of log data (active DB log data 12a) upon receiving an operation command as a log data transmission trigger (S413, S415).

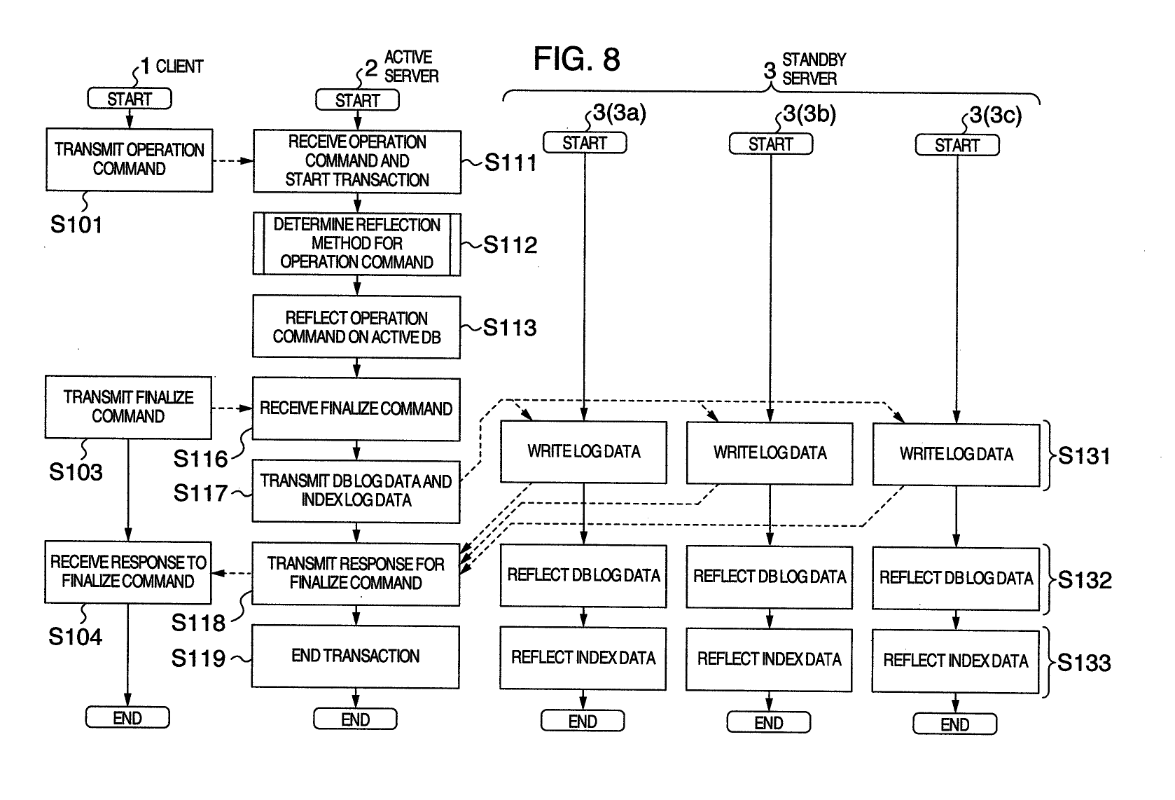

FIG. 8 is a flow chart showing the process of executing the reflection method (1) of FIG. 4 with the standby server 3 of the clustering configuration shown in FIG. 1.

First, when it sends two kinds of log data (S117), it is desired that the active server 2 transmit them to standby servers 3 (standby server 3a, standby server 3b, standby server 3c) in one multicast operation. This can enhance the utilization of network while preventing its possible congestions.

Then, the active server 2 may return a response (S118) to the finalize command it received from the client 1 (S116) on condition that it receives all ACKs (in FIG. 8, three ACKs) from standby servers 3 to which log data were transmitted in S117.

As described above, this embodiment is characterized in that there are two or more data synchronization methods (data reflection methods) between the active server 2 and the standby server 3 and that an optimal data reflection method is chosen according to the utilization of the resources of the active server 2 and the standby server 3.

This allows for a selection of an optimal data reflection method that is given priority to use available resources even if the resource utilization varies due to load variations during system operation, hardware failures and system configuration changes. Therefore the database system as a whole including both the active server 2 and the standby server 3 can be enhanced in reliability and availability.

It should be further understood by those skilled in the art that although the foregoing description has been made on embodiments of the invention, the invention is not limited thereto and various changes and modifications may be made without departing from the spirit of the invention and the scope of the appended claims.

1. A data synchronization method for synchronizing data between an active database and a standby database in a database system, the database system being redundantly configured by having an active server to update data according to a command from a client and a standby server to take over processing from the active server in the event of a failure of the active server;
wherein the active server has the active database and the standby server has the standby database;
wherein the active server has, in addition to the active database, a resource utilization table, a resource utilization monitoring unit, a transaction control unit and a data reflection method selection unit; and
wherein the standby server has a log data application unit in addition to the standby database;
the method comprising the steps of:
starting, when the transaction control unit receives an operation command for specifying and updating data content, a transaction to process the received operation command and then reflecting on the active database the content specified by the received operation command;
collecting, by the resource utilization monitoring unit, at least utilization information on resources in each of the servers making up the database system or database operation information, and storing them in the resource utilization table;
weighting, by the data reflection method selection unit, collected values in the resource utilization table by multiplying the collected values by assessment coefficients assigned to the individual collected values in an assessment coefficient table, summing up the weighted values to calculate an assessment value for each data reflection method, and determining the data reflection method whose assessment value is minimum;
sending, by a log data transmission unit according to the determined data reflection method, log data that is reflected on the active database to the standby server, which forms one of the duplicated servers making up the redundant configuration; and
reflecting, by the log data application unit, when a finalize command to finalize the transaction is transmitted from the client to the active server, the received log data on the standby database,
wherein the data reflection method is defined by selecting one of log data content transmitting methods shown in (a) and (b):
(a) Transmitting data log representing a content of data to be updated in the database but not an index log representing a content of index update to the content of data, the index log being created on the standby server side instead; and
(b) Transmitting index log in addition to the data log.

2. The data synchronization method according to claim 1, wherein the data reflection method selection unit selects, based on the assessment value, either a data reflection method that takes a reception of the operation command as a trigger for the log data transmission or a data reflection method that takes a reception of the finalize command as a trigger for the log data transmission.

3. The data synchronization method according to claim 1, wherein the active server stores in memory the data to be stored in the active database and the standby server stores in memory the data to be stored in the standby database.

4. The data synchronization method according to claim 1, wherein two or more of the standby servers are provided in the database system and the log data transmission unit transmits, according to the selected data reflection method, the log data in a multicast communication to the plurality of standby servers, which form one of the duplicated servers making up the redundant configuration.

5. A data synchronization program to cause the active server and the standby server, both composed of computers, to execute the data synchronization method according to claim 1.

6. A database server device for synchronizing data between an active database and a standby database in a database system, the database system being redundantly configured by having an active server to update data according to a command from a client and a standby server to take over processing from the active server in the event of a failure of the active server;
wherein the active server has the active database and the standby server has the standby database;
wherein the active server has, in addition to the active database, a resource utilization table, a resource utilization monitoring unit, a transaction control unit and a data reflection method selection unit; and
wherein the standby server has a log data application unit in addition to the standby database,
said database server device comprising:
a constitutional element of the active server; and
a constitutional element of the standby server,
wherein the database server device switches between the active server and the standby server;
wherein the transaction control unit, when it receives an operation command for specifying and updating data content, starts a transaction to process the received operation command and then reflects on the active database the content specified by the received operation command;
wherein the resource utilization monitoring unit collects at least utilization information on resources in each of the servers making up the database system or database operation information and stores them in the resource utilization table;
wherein the data reflection method selection unit weights collected values in the resource utilization table by multiplying the collected values by assessment coefficients assigned to the individual collected values in an assessment coefficient table and sums up the weighted values to calculate an assessment value for each data reflection method, and determines the data reflection method whose assessment value is minimum;
wherein a log data transmission unit, according to the determined data reflection method, sends log data that is reflected on the active database to the standby server, which forms one of the duplicated servers making up the redundant configuration;
wherein, when a finalize command to finalize the transaction is transmitted from the client to the active server, the log data application unit reflects the received log data on the standby database;
wherein the data reflection method is defined by selecting one of log data content transmitting methods shown in (a) and (b):
(a) Transmitting data log representing a content of data to be updated in the database but not an index log representing a content of index update to the content of data, the index log being created on the standby server side instead; and
(b) Transmitting index log in addition to the data log.

7. The database server device according to claim 6, wherein the data reflection method selection unit selects, based on the assessment value, either a data reflection method that takes a reception of the operation command as a trigger for the log data transmission or a data reflection method that takes a reception of the finalize command as a trigger for the log data transmission.

8. A database system comprising:
an active server and;
a standby server,
wherein the active server and the standby server are configured to be for redundant configuration and synchronize data between an active database of the active server and a standby database of the standby server in the database system, wherein the active server updates data according to a command from a client and the standby server takes over processing from the active server in the event of a failure of the active server;
wherein the active server has, in addition to the active database, a resource utilization table, a resource utilization monitoring unit, a transaction control unit and a data reflection method selection unit;
wherein the standby server has a log data application unit in addition to the standby database;
wherein the transaction control unit, when it receives an operation command for specifying and updating data content, starts a transaction to process the received operation command and then reflects on the active database the content specified by the received operation command;
wherein the resource utilization monitoring unit collects at least utilization information on resources in each of the servers making up the database system or database operation information and stores them in the resource utilization table;
wherein the data reflection method selection unit weights collected values in the resource utilization table by multiplying the collected values by assessment coefficients assigned to the individual collected values in an assessment coefficient table and sums up the weighted values to calculate an assessment value for each data reflection method, and determines the data reflection method whose assessment value is minimum;
wherein a log data transmission unit, according to the determined data reflection method, sends log data that is reflected on the active database to the standby server, which forms one of the duplicated servers making up the redundant configuration;
wherein, when a finalize command to finalize the transaction is transmitted from the client to the active server, the log data application unit reflects the received log data on the standby database;
wherein the data reflection method is defined by selecting one of log data content transmitting methods shown in (a) and (b):
(a) Transmitting data log representing a content of data to be updated in the database but not an index log representing a content of index update to the content of data, the index log being created on the standby server side instead; and
(b) Transmitting index log in addition to the data log.

9. The database system according to claim 8, wherein the data reflection method selection unit selects, based on the assessment value, either a data reflection method that takes a reception of the operation command as a trigger for the log data transmission or a data reflection method that takes a reception of the finalize command as a trigger for the log data transmission.

10. The database system according to claim 8, wherein the active server stores in memory the data to be stored in the active database and the standby server stores in memory the data to be stored in the standby database.

11. The database system according to claim 8, wherein two or more of the standby servers are provided in the database system and the log data transmission unit transmits, according to the selected data reflection method, the log data in a multicast communication to the plurality of standby servers which form one of the duplicated servers making up the redundant configuration.
